(19) United States
(12) Patent Application Publication
(10) Pub. No.: US 2005/0038735 A1
(43) Pub. Date: Feb. 17, 2005

(54) Card holder application status system and method

(75) Inventors: Mary L. Goldman, Mount Dora, FL (US); Debbie G. Holmes, Boca Raton, FL (US); Gordon R. Hunt, Scottsdale, AZ (US); Gary G. Luke, West Valley City, UT (US); Sukumar J. Rajagopalan, Plainsboro, NJ (US); Debra L. Varty, Chandler, AZ (US); Vinod Y. Yadav, Phoenix, AZ (US)

Correspondence Address: SNELL & WILMER;ONE ARIZONA CENTER, 400 EAST VAN BUREN, PHOENIX, AZ, 850040001, US

(73) Assignee: American Express Travel Related Services Company, Inc.

(21) Appl. No.: 10/914,667

(22) Filed: Aug. 9, 2004

Related U.S. Application Data
(60) Provisional application No. 60/494,305, filed on Aug. 11, 2003.

(51) Int. Cl. G06F 17/60

(52) U.S. Cl. 705/38

(57) ABSTRACT

Facilitating the processing of requests for status of an application for a credit card or other financial instrument. An applicant for the financial instrument provides a request for status of the application, including with the request information related to an identification of the applicant. The request is validated using the identification information, and status information related to the request is obtained, if available. Based upon the validation and status information, if available, the status information is selectively providing to the applicant via a non-voice communication such as in an e-mail or web page.

### REFERENCE TO RELATED APPLICATION

The present application is related to, and claims priority to, U.S. Provisional Patent Application Ser. No. 60/494,305 filed Aug. 11, 2003 and entitled “Application Status System and Method,” which is incorporated herein by reference.

### FIELD OF INVENTION

The present invention relates to an apparatus and method for providing status information to applicants for cards or other financial instruments via electronic communications.

### BACKGROUND OF THE INVENTION

Customers typically apply on-line or via mail for a credit card or other financial instrument. Following submission of the application, however, the customers usually receive little or no communication concerning the status of the application while it is pending. To inquire into the status of the applications, the customers usually call a customer service representative associated with the card issuer. However, due to the lack of communication during the application process, the card issuers often receive a high volume of in-bound calls from customers inquiring about the status. This call volume requires the customer service representatives to direct their attention and duties away from other tasks and can result in the need to have a large staff of customer service representatives to handle the calls.

Accordingly, a need exists to provide customers with status information concerning applications for credit cards or other financial instruments while the applications are pending.

### SUMMARY OF THE INVENTION

The invention facilitates the processing of requests for status information related to an application. In one embodiment, an applicant for a financial instrument sends a request for status information related to a financial instrument application. In response to the request, information related to the application is obtained and provided to (or made available to) the applicant in a communication without human assistance such as, for example, an e-mail or web page.

In another embodiment, an applicant for a financial instrument provides a request for status information related to the application, including with the request information related to an identification of the applicant. The system validates the request using the information and attempts to obtain status information related to the request. Based upon the validating and attempting, the status information related to the request is selectively provided to (or made available to) the applicant via a communication without human assistance such as, for example, an e-mail or web page.

### BRIEF DESCRIPTION OF THE DRAWINGS

The accompanying drawings, wherein like reference numerals represent like elements, are incorporated in and constitute a part of this specification and, together with the description, explain the advantages and principles of the invention. In the drawings,

FIG. 1 is a diagram of an exemplary system for processing status requests;

FIG. 2 is a diagram of exemplary components of a system for executing the present invention;

FIG. 3 is a flow chart of an exemplary method for requesting application status;

FIG. 4 is a flow chart of an exemplary method for checking application status data;

FIG. 5 is a flow chart of an exemplary method for checking application status;

FIG. 6 is a diagram of an exemplary welcome page screen shot;

FIG. 7 is a diagram of an exemplary status page screen shot;

FIG. 8 is a diagram of an exemplary thank you page screen shot; and

FIG. 9 is a diagram of an exemplary unable to locate application screen shot.

### DETAILED DESCRIPTION

Introduction

The invention provides application status information via e-mails or other electronic communications to certain applicants at key points in the approval process. The applications may be associated with any information, business, service, goods, and/or the like. In one embodiment, the applications are associated with financial transactions or transaction accounts. The e-mails or other electronic communications may occur in real-time, substantially real-time, at a delayed time, at pre-determined intervals, periodic times, random times or at times associated with certain events. The notifications may expedite the approval process because the e-mails may request any needed additional information at certain points in the process in order to avoid delays. Three exemplary e-mail types may include: Application Received (to be sent when the card application is received by the host), ‘We Need’ (indicating additional information is needed to complete the approval process), and Decision (indicating a decision has been reached). In an exemplary embodiment, the application status may be provided in an electronic communication without human assistance in order to reduce in-coming telephone calls from applicants requesting status of their applications. Examples of communications which do not include human assistance or include minimal human assistance include, for example, e-mails, web pages, and other types of communications discussed herein or known in the art.

An on-line web site with web pages is also available wherein applicants can view their application status. The on-line web site may include update capabilities, wherein the applicant can input or enter the requested information into a web page which is transmitted to the host and the host can then immediately use that information to continue the application approval process.

The e-mail may contain an embedded uniform resource locator (URL) that may transfer the applicant to the on-line status site wherein the applicant can view status information related to an account by using, for example, an account code. Once the e-mail is sent, the host may obtain e-mail tracking information related to, for example, bounceback, open (when the user opens the e-mail), and “click-thru” (when the user clicks the link embedded in the e-mail).

Network Environment

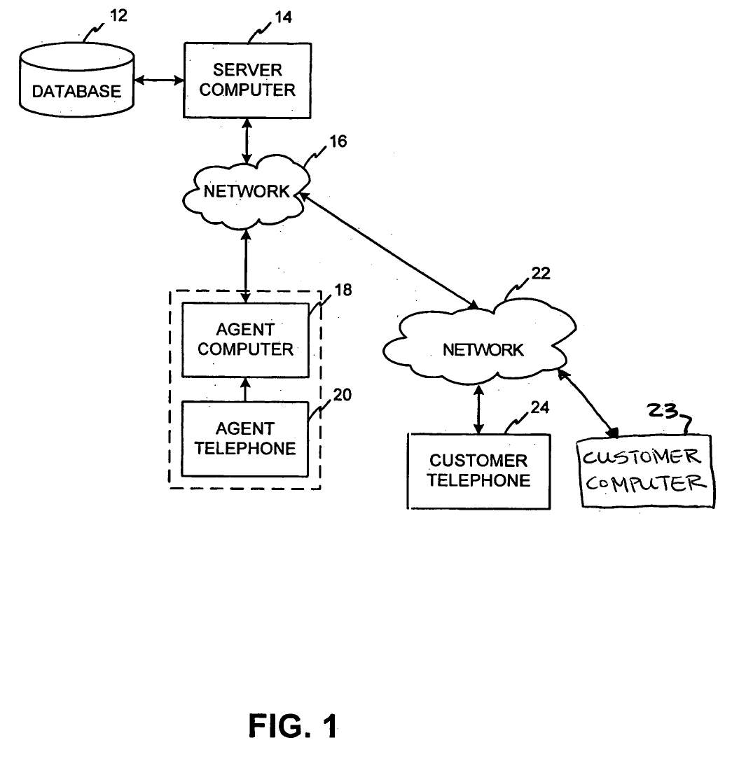

An exemplary system 10 for processing requests for application status information is shown in FIG. 1. System 10 includes, in one embodiment, an agent computer 18 having a connection via a network 16 with a server computer 14. Agent computer 18 also includes an associated agent telephone or other oral communication device 20. System 10 includes a customer telephone or other oral communication device 24, along with a customer computer 23 for a customer to contact an agent at agent telephone 20, or computer 18, via a network 22, if necessary or desired. System 10 may use server 14 to maintain a status web site in order to programmatically process requests for application status information without requiring manual intervention by an agent.

While the system will be described herein with respect to telephone communications, one skilled in the art will appreciate that any communication device now known or hereinafter developed may also be used in the present invention. Moreover, while the system and method of the present invention may apply to network communications, one skilled in the art will appreciate that the present invention may be implemented with other types of communications. Networks 16 and 22 can include any wireline or wireless network for data transmission such as, for example, a Transmission Control Protocol/Internet Protocol (TCP/IP) network.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

The system may include a host server or other computing systems (e.g., at server computer 14, agent computer 18, customer 24, or customer computer 23) including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, customer computer will typically include an operating system (e.g., Windows NT, 95/98/2000, Linux, Solaris, etc.) as well as various conventional support software and drivers typically associated with computers. Customer computer can be in a home or business environment with access to a network. In an exemplary embodiment, access is through the Internet through a commercially-available web-browser software package.

Communication between the parties to the transaction (e.g., network 22) and the system (e.g., network 16) of the present invention may be accomplished through any suitable communication means, such as, for example, a telephone network, Intranet, Internet, point of interaction device (point of sale device, personal digital assistant, cellular phone, kiosk, etc.), on-line communications, off-line communications, wireless communications, transponder communications and/or the like. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption, compression, decompression, and/or the like.

As described herein, the computing units may be connected with each other via a data communication network. The network may be a public network and assumed to be insecure and open to eavesdroppers. The network may be embodied as the internet. In this context, the computers may or may not be connected to the internet at all times. For instance, the customer computer may employ a modem to occasionally connect to the internet, whereas the computer may maintain a permanent connection to the internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

The systems may be suitably coupled to the networks via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. The system might also reside within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

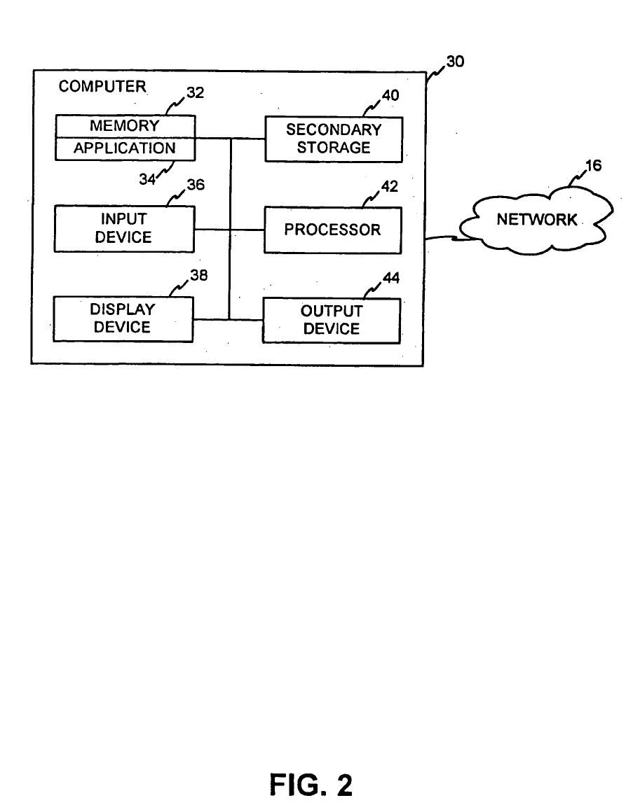

FIG. 2 is a diagram of a exemplary computer 30 illustrating typical components of server computer 14 and agent computer 18. Computer 30 can include a connection with network 16 such as the Internet through any suitable network connection. Computer 30 typically includes a memory 32, a secondary storage device 40, a processor 42, an input device 36 for entering information into computer 30, a display device 38 for providing a visual display of information, and an output device 44 for outputting information such as in hard copy or audio form. Memory 32 may include random access memory (RAM) or similar types of memory, and it may store one or more applications 34 for execution by processor 42.

Secondary storage device 40 may include a hard disk drive, floppy disk drive, CD-ROM drive, or other types of non-volatile data storage. Processor 42 may execute applications or programs stored in memory 34 or secondary storage 40, or received from the Internet or other network 16. Although computer 30 is depicted with various components, one skilled in the art will appreciate that the server and agent computers can contain different components.

The computers discussed herein may provide a suitable web site or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system.

Any of the communications, inputs, storage, databases or displays discussed herein may be facilitated through a web site having webpages. The term “webpage” as it is used herein is not meant to limit the type of documents and applications that might be used to interact with the user. For example, a typical web site might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

It will be appreciated that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The parties may interact with the system via any input device such as a keyboard, mouse, kiosk, personal digital assistant, handheld computer (e.g., Palm Pilot®), cellular phone and/or any suitable communication or data input modality. Similarly, the invention could be used in conjunction with any suitable personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, the invention may also be implemented using IPX, Appletalk, IP-6, NetBIOS, OSI or any number of existing or future protocols. Moreover, the system contemplates the use, sale or distribution of any goods, services or information over any network having similar functionality described herein.

Application Status Methods

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flow chart illustrations of methods, apparatus (e.g., systems), and computer program products according to various aspects of the invention. It will be understood that each functional block of the block diagrams and the flow chart illustrations, and combinations of functional blocks in the block diagrams and flow chart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flow chart block or blocks.

These computer program instructions may also be stored in a computer-readable memory that can direct a computer or other programmable data processing apparatus to function in a particular manner, such that the instructions stored in the computer-readable memory produce a module or an article of manufacture including instruction means which implement the function specified in the flow chart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow chart block or blocks.

Accordingly, functional blocks of the block diagrams and flow chart illustrations support combinations of means for performing the specified functions, combinations of steps for performing the specified functions, and program instruction means for performing the specified functions. It will also be understood that each functional block of the block diagrams and flow chart illustrations, and combinations of functional blocks in the block diagrams and flow chart illustrations, can be implemented by either special purpose hardware-based computer systems which perform the specified functions or steps, or suitable combinations of special purpose hardware and computer instructions.

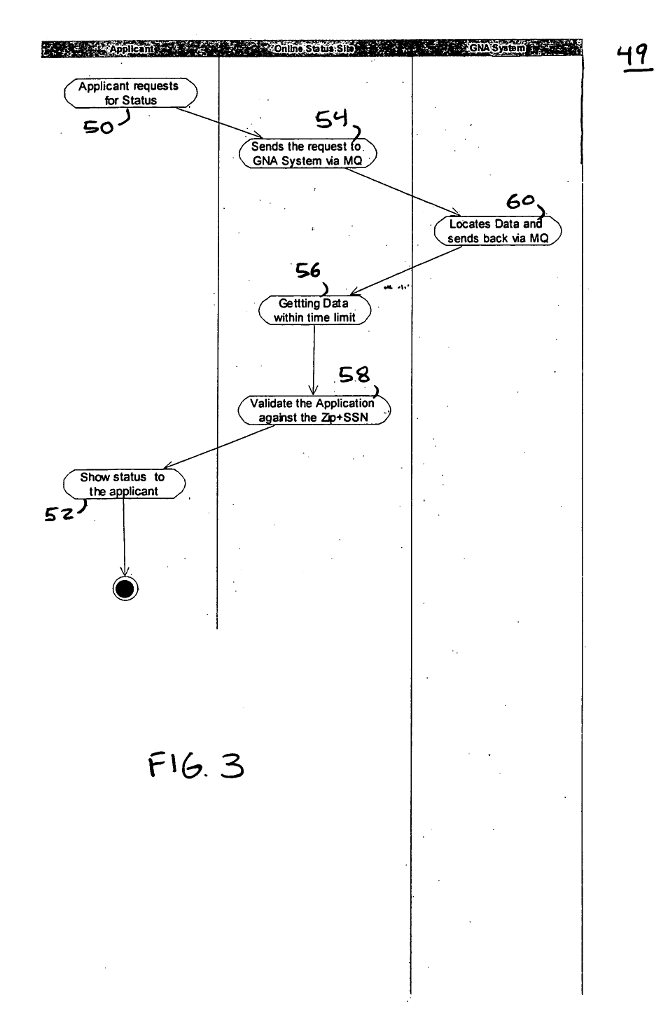

FIG. 3 is a flow chart of an exemplary application status request method 49, illustrating interaction between an applicant or customer, an on-line status site, and a system referred to in this example as a Global New Accounts (GNA) system to process the applications. In method 49, an applicant requests status via a network, such as through an e-mail communication or a web page, to the on-line status site (step 50), which sends the request to the GNA system via MQ (step 54). The GNA system locates data corresponding with the application and sends the data back to the on-line status site via the MQ (step 56). The on-line status site checks for receipt of the data from the GNA system within a particular time limit (step 56) and validates the application against the applicant's zip code and social security number, in this example (step 58). If correctly validated, the on-line status site provides the status to the applicant via a network such as in an e-mail or web page (step 52). The information may be organized or formatted in any suitable manner. In one embodiment, the status is provided in an electronic non-voice electronic communication without human intervention, as identified above.

In another embodiment (or as an alternative to use of a social security number and zip code to look-up a customer's application), the system may use an account or an account number corresponding with the customer's application. An “account” or “account number”, as used herein, may include any device, code, number, letter, symbol, digital certificate, smart chip, digital signal, analog signal, biometric or other identifier/indicia suitably configured to allow the consumer to access, interact with or communicate with the system such as, for example, one or more of an authorization/access code, personal identification number (PIN), Internet code, other identification code, and/or the like which may optionally be located on or associated with a rewards card, charge card, credit card, debit card, prepaid card, telephone card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the customer. A merchant account number may be, for example, any number or alpha-numeric characters that identifies a particular merchant for purposes of card acceptance, account reconciliation, reporting, or the like.

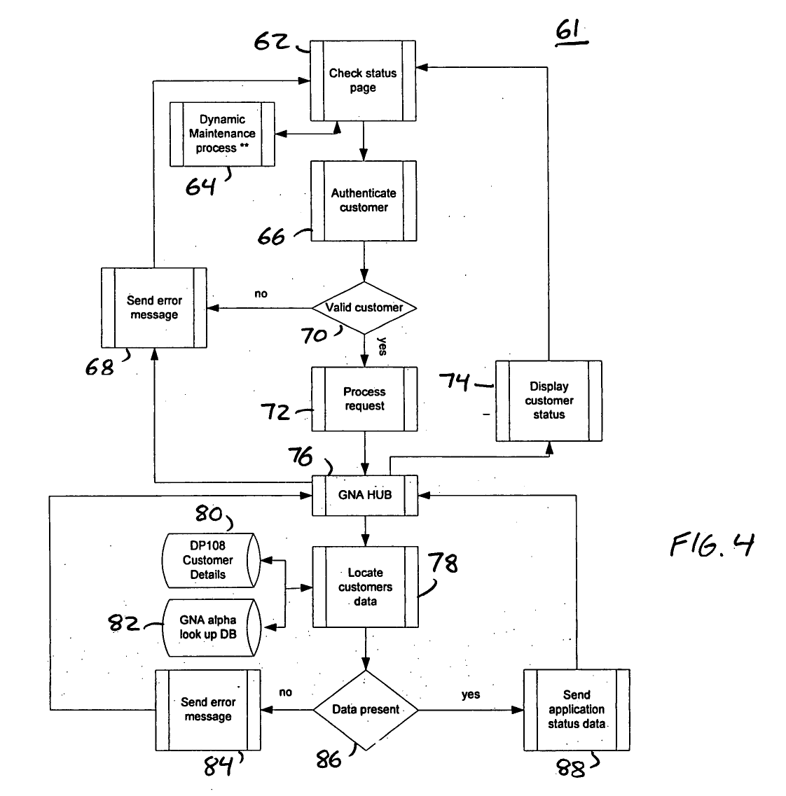

FIG. 4 is a flow chart of an exemplary check application status method 61, as executed in this example by the on-line status site and the GNA system. In method 61, the system checks a status page (step 62) and may perform an associated dynamic maintenance process (step 64). The dynamic maintenance process, in this example, allows the card issuer to control one or more of the elements appearing on the status page, as viewed by applicants or customers.

Examples of screens or web pages corresponding with the status methods are identified and explained below. In this embodiment, the customer may enter information into a web form or send an e-mail with certain information. In another embodiment, a customer service representative may request certain information from the customer and enter the information into the system. In this regard, the computers discussed herein may provide a suitable web site, webpage or other Internet-based graphical customer interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system. The term “webpage” as it is used herein is not meant to limit the type of documents and applications that might be used to interact with the user. For example, a typical web site might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

Upon receiving a request for status of an applicant, the system may authenticate the customer (step 66) and, if it is not a valid customer (step 70), the system may send an error message to the customer such as via an e-mail or web page (step 68). If the customer is valid (step 70), the system processes the customer's request (step 72) via a GNA hub (step 76) such as the on-line status site. The GNA hub attempts to locate the customer's data (step 78) from a customer details database 80 and an associated alpha look-up database 82.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The present invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

If the data is present in the databases (step 86), the GNA hub sends the application status data (step 88) via the GNA hub for display to the customer such as in an e-mail or web page (step 74). If the data for the customer's request is not present (step 86), an error message is returned to the GNA hub (step 84).

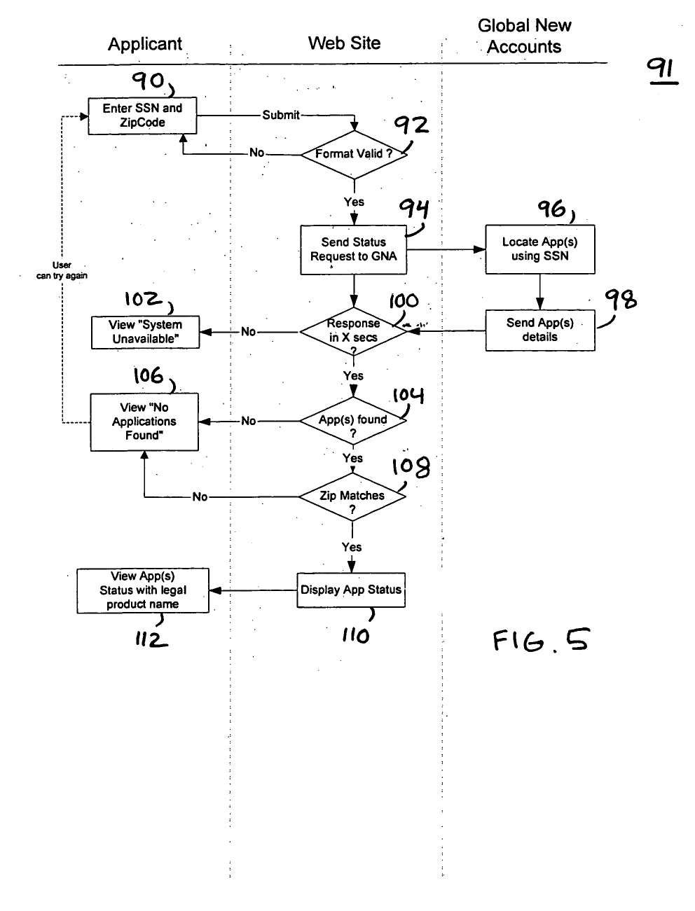

FIG. 5 is a flow chart of an exemplary application status method 91, illustrating in more detail how the on-line status site (GNA hub) processes the requests for step 76, and the interaction among the customer, on-line status site, and GNA system. In method 91, the customer or applicant provides his or her zip code and social security number for the request (step 90). This information can be transmitted via a network such as in an e-mail or entered via a status web page. The on-line status site may determine if the submitted information is valid by, for example, looking up the customer's information in a database (step 92). If the information is valid, the on-line status site sends the status request to the GNA system (step 94), which locates the customer's application using the customer's submitted social security number (step 96) and returns the customer's application details to the on-line status site (step 98). During the process of the GNA system looking up the customer's application details, the on-line status site determines whether it receives a response from the GNA system within a particular time frame such as, for example, a certain number of seconds or other time parameter (step 100). If no response is received within that time frame (step 100), the on-line status site provides a message to the customer, such as in a web page, that the system is unavailable (step 102) to avoid having the customer wait too long for a response in this example.

If the on-line status site receives a response from the GNA system within the particular time frame (step 100), it determines if the customer's application details were located by the GNA system (step 104). If the application was not found, the on-line status site provides a message to the customer, such as in a web page, that no applications were found for the customer (step 106). Otherwise, if the application details were found by the GNA system (step 104), the on-line status site determines if the customer's submitted zip code matches a zip code “on file” for the customer such as within databases 80 and 82 (step 108).

If the zip code information does not match (step 108) in method 91, the on-line status site may provide to the customer the message that no applications were found (step 106). Otherwise, if the zip code information matches (step 108), the on-line status site provides to the customer the application status (step 110), which the customer may view such as in an e-mail or web page (step 112).

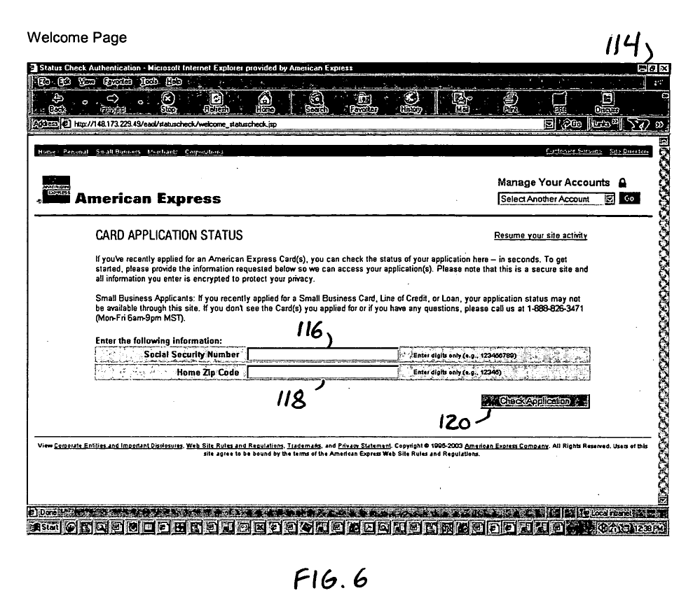

FIGS. 6-9 provide diagrams of exemplary web pages or screens for use in conjunction with executing methods 49, 61, and 91. FIG. 6 is a diagram of an exemplary welcome page screen 114. In screen 114, the customer may enter his or her social security number in a section 116 and zip code in a section 118. The customer may then select a section 120 to submit the request for application status, as described above, along with the social security number and zip code, to the on-line status site.

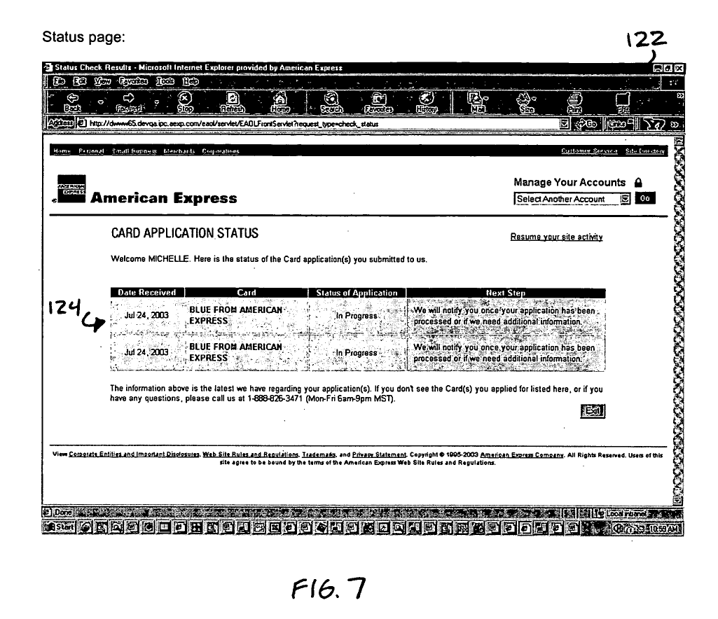

FIG. 7 is a diagram of an exemplary status page screen 122. In screen 122, the on-line status site can provide to the customer, in a section 124, status information concerning the customer's application, when correctly validated and available, as explained above. In this example, section 124 provides the following status information to the customer: the date of receipt for the application; the card or other financial instrument requested; the status of the application (for example, “in progress”); and the next step in the application process. Other types of status information, or different types, can also be provided depending upon particular implementations.

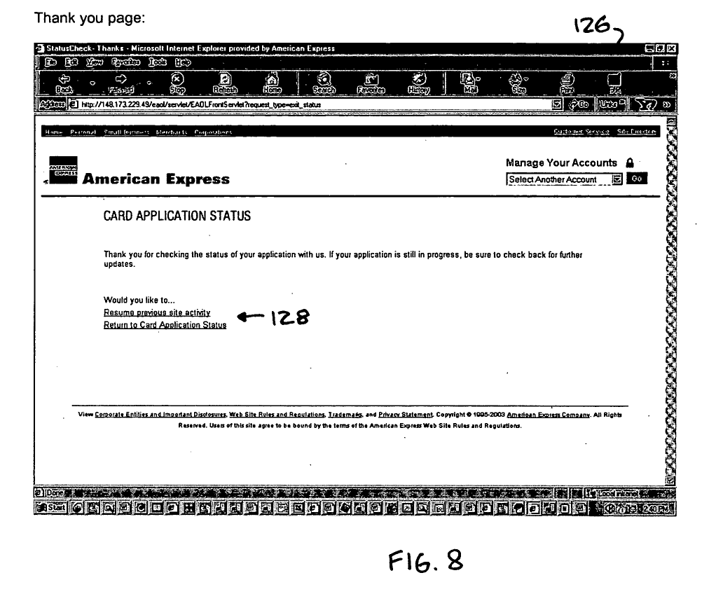

FIG. 8 is a diagram of an exemplary thank you page screen 126. In screen 126, the on-line status site can provide a “thank you” message to the customer, as illustrated in a section 128.

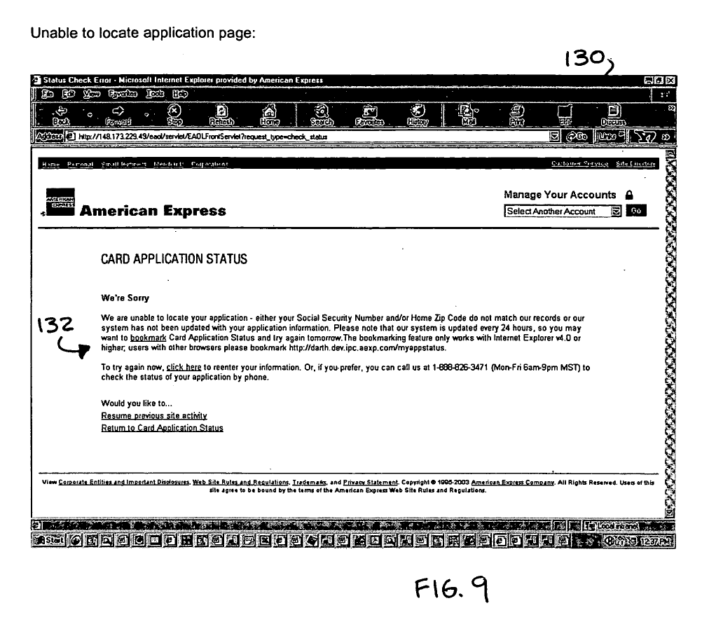

FIG. 9 is a diagram of an exemplary “unable to locate application” page screen 130. When the on-line status site and GNA system are unable to locate application details for a particular customer, as explained above, the on-line status site can display screen 130 to the customer. Screen 130 provides an example of a message, in a section 132, that can be provided to the customer explaining that no applications were found for the customer.

The detailed description of exemplary embodiments of the invention herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A method for facilitating the processing of requests for status information related to an application, comprising:
receiving, from an applicant, a request for status information related to an application for a financial instrument;
obtaining information related to the request; and
providing via a non-voice electronic communication the information for the request.

2. The method of claim 1, further including validating the request for the status.

3. The method of claim 1 wherein the providing step includes providing the information in a web page.

4. The method of claim 2, further including obtaining from the applicant information identifying the applicant for use in validating the request.

5. The method of claim 1, further including attempting to obtain the information within a particular time frame.

6. The method of claim 1, further including providing an error message to the applicant if the information related to the request is not available.

7. The method of claim 1 wherein the providing step includes providing a date of the application, an identification of the financial instrument requested in the application, and a status of the application.

8. An apparatus for facilitating the processing of requests for status information related to an application, comprising:
a receive module for receiving, from an applicant, a request for status information related to an application for a financial instrument by the applicant;
an information module for obtaining information related to the request; and
a provide module providing via a non-voice electronic communication the information for the request.

9. The apparatus of claim 8, further including a module for validating the request for the status.

10. The apparatus of claim 8 wherein the provide module includes a module for providing the information in a web page.

11. The apparatus of claim 9, further including a module for obtaining from the applicant information identifying the applicant for use in validating the request.

12. The apparatus of claim 8, further including a module for attempting to obtain the information within a particular time frame.

13. The apparatus of claim 8, further including a module for providing an error message to the applicant if the information related to the request is not available.

14. The apparatus of claim 8 wherein the provide module includes a module for providing a date of the application, an identification of the financial instrument requested in the application, and a status of the application.

15. A method for facilitating the processing of requests for status information related to an application, comprising:
receiving, from an applicant, a request for status information related to an application for a financial instrument by the applicant, the request including information related to an identification of the applicant;
validating the request using the information;
attempting to obtain status information related to the request; and
based upon the validating steps, selectively providing to the applicant, via a non-voice electronic communication, the status information related to the request.

16. The method of claim 15 wherein the providing step includes providing the information in a web page.

17. The method of claim 15 wherein the attempting step includes accessing a system via a network connection in order to attempt to obtain the status information from the system.

18. The method of claim 15, further including providing, via the non-voice electronic communication, the status information at particular points during processing of the application.
